(19) United States
(12) Patent Application Publication
(10) Pub. No.: US 2009/0078108 A1
(43) Pub. Date: Mar. 26, 2009

(54) Musical composition system and method

(76) Inventors: Rick Rowe, Las Vegas, NV (US); Kevan Wilkins, Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 12/284,320

(22) Filed: Sep. 18, 2008

Related U.S. Application Data
(60) Provisional application No. 60/994,904, filed on Sep. 20, 2007.

(51) Int. Cl. G10H 1/00

(52) U.S. Cl. 84/601

(57) ABSTRACT

The invention is a method and system for accessing a plurality of musical tracks and mixing two or more of those musical tracks into a new work. A plurality of individual tracks or works is located at a location accessible to a large number of users, such as a main server. A user may select and access the works, including by transferring the works to their location for mixing or combining those works into new works. The user may create a command or conductor file which causes the server to perform the works in accordance with commands defined by the user.

### PRIOR APPLICATION DATA

This application claims priority to U.S. Provisional Patent Application Ser. No. 60/994,904, filed Sep. 20, 2007.

### FIELD OF THE INVENTION

The present invention relates to methods and systems for accessing and mixing music.

### BACKGROUND OF THE INVENTION

Conventional music studios consist of recording studios where expensive equipment is used to record artists. With the reduction in price of this equipment, music equipment has become available to individuals for use in home recording studios where high quality recordings can be made at low cost. Using software available for the home studio, individual tracks of music are recorded such as drums, guitar, vocals, etc. and rendered or mixed together creating a single data file with the combined tracks. Newer methods as taught by Williams U.S. Pat. No. 7,191,023, uses a central server to mix a plurality of tracks selected by the user. The user selects the stored tracts in the database, mixes them and generates a single musical track in a compressed high fidelity or stereo format.

Both the conventional methods and the Williams method generate a new music data file from the mixed tracks representing the combination of tracks rendered together that can be played directly. Such a method has many limitations. As the Williams '023 patent teaches, “once the tracks are mixed, it is impossible to ‘unmix’ them. Sounds are so intertwined within the digital information, it is next to impossible to extract the original and separate tracks.” Thus new musical works are created in the form of a single data file from multiple tracks which were stored in multiple data files. As new mixes are created, many new files are generated making it next to impossible to track royalty distribution to artists who may have create one or more tracks for the derivative work new file and requiring a large amount of disk space to store the many new files created from existing track files.

Another issue relates to possible legal problems that may come up associated with a derivative work mixed data file. For example, the Williams '023 patent teaches “transferring said mixed plurality of data files from said server to said corresponding clients via said distributed network.” Once a new file is created, it is transferred to the clients making it impossible for the artist to control the distribution of the new file after it has been transferred to the client. Further, where a legal challenge may occur, the artist has no ability to recall this new file from the plurality of clients that may have received it. Such limitations create major challenges for record companies who manage many artists which makes the Williams '023 system unpractical for professional use.

In order to address the issues of distribution control and artist control of a derivative work created from the work of many artists and address the professional needs of record industry for control and tracking of derivative works, a new system and method is needed that may be used reliably by record companies and professional artists.

### SUMMARY OF THE INVENTION

One aspect of the invention is a method and system for accessing a plurality of audio and/or visual tracks or works (such as musical tracks). The method and system permit the combination or mixing of two or more of the tracks into a new work.

In a preferred embodiment, the system is an online system in which a plurality of audio and/or visual tracks or works is located at a central server. The tracks or works may be provided by a plurality of artists. The tracks or works may be played or presented individually or together on the server, or streamed or downloaded to a client. The client may create new works from the individual works, such as by mixing two or more of the downloaded works at a client computer or workstation, without changing the original works stored centrally.

In one embodiment, a plurality of original tracks is stored on a central server in a musical repository. The user selectors or purchases a plurality of audio and/or visual tracks and provides input regarding use of those tracks. In one embodiment, that input comprises a plurality of rules defining how the tracks are to be played or performed. Such input may be provided by an interface, such as a website graphical interface. The rules or instructions may be stored as a file, such as a command or conductor file. The server is configured to present the tracks in unified form in accordance with the command file. Preferably, such is accomplished without changing the original tracks or files.

Further objects, features, and advantages of the present invention over the prior art will become apparent from the detailed description of the drawings which follows, when considered with the attached figures.

### DESCRIPTION OF THE DRAWINGS

FIG. 1 illustrates a conductor file in accordance with the present invention;

FIG. 2 illustrates a system in accordance with an aspect of the invention;

FIG. 3 illustrates additional systems in accordance with an aspect of the invention;

FIGS. 4 and 5 illustrate a method in accordance with the invention;

FIG. 6 illustrates an aspect of track selection in accordance with the invention;

FIG. 7 illustrates an aspect of track manipulation in accordance with the invention;

FIG. 8 illustrates another conductor file in accordance with the invention; and

FIG. 9 illustrates a method of playing multiple tracks in accordance with the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One embodiment of the invention is a method and system for accessing a plurality of musical tracks and mixing two or more of those musical tracks into a new work, such as user-created compilation work. In the preferred embodiment of the invention, a plurality of works is located at a location accessible to a large number of users. The users may access the works, including by transferring the works to their location for mixing or combining those works into new works.

In a preferred embodiment, the system is an online system in which a plurality of musical tracks or works is located at a central server (which central server may comprise a single device or multiple or distributed devices, such as a multiple servers linked to one or more internal or external data storage devices). The tracks or works may be provided by a plurality of artists. The tracks or works may be played or presented individually or together on the server, or streamed or downloaded to a client. The client may create new works from the individual works, such as by mixing two or more of the downloaded works at a client computer or workstation, without changing the original works stored centrally.

In one embodiment, a plurality of original music tracks is stored on a central server in a musical repository. The user purchases a plurality of musical tracks and provides input regarding use of those tracks. In one embodiment, that input comprises a plurality of rules defining how the tracks are to be played. Such input may be provided by an interface, such as a website GUI, such as a “conductor” interface. The rules or instructions may be stored as a file, such as a “conductor” file.

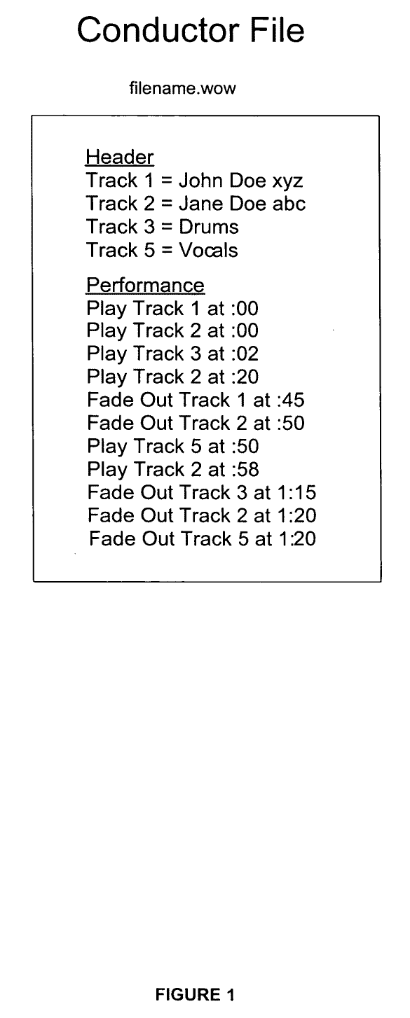

The plurality of original musical tracks is played by the server simultaneously using the user created conductor data file. Such a file or instructions may relate to when and how each individual track should be played. For example, the user may wish to use a drums track, a guitar track, a vocal track, and a bass track. As indicated, the user may utilize a web interface provided at the client's computer from the server, by which the user interacts with the system to generate the instructions for how to play each of the individual tracks. As one example, the user may direct the system to play drums, bass starting from 0 to 10 seconds, then bring in track 1 at 10 seconds, track 2 at 15 seconds, fade out track 2 at 30 seconds, etc. One example of a conductor file conductor.wow is illustrated in FIG. 1. Once that file is prepared, the file is used by the server to simultaneously play the specific tracks as described in the conductor file.

The system may provide the user with a variety of commands or instructions for each individual track including, but not limited to: on, off, fade in, fade out, volume up, volume down, tempo, key, add effect, transition, treble, bass, etc.

In a preferred embodiment of the invention, when the system plays the tracks in accordance with the user's instructions or commands, the system does not modify the original tracks on the system. Instead, the original tracks remain exactly how the artist created them, while the conductor file (*.wow) directs the system to play or present the track(s) on the server as defined by that file.

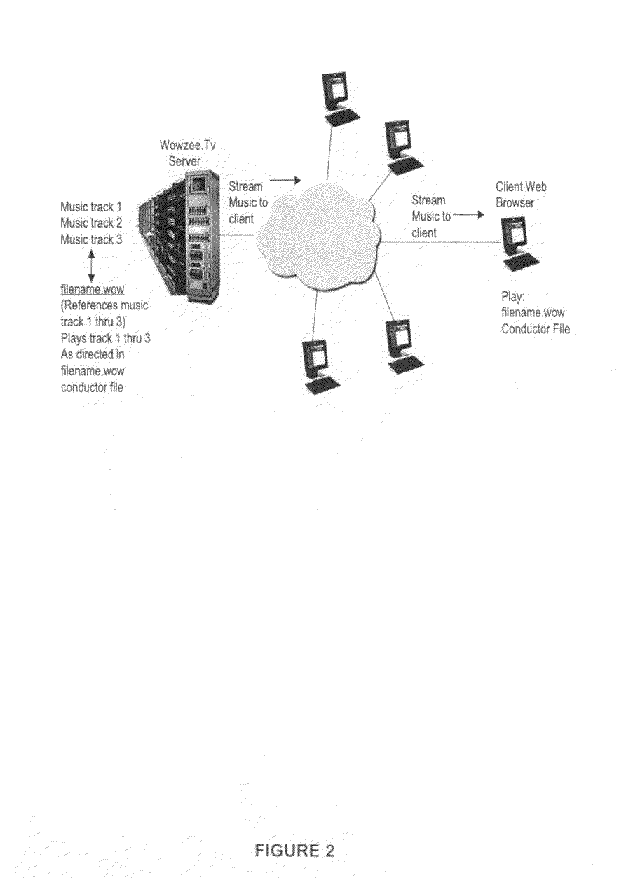

One example of this system is illustrated in FIG. 2, wherein individual tracks are stored at a server which is accessible to a plurality of users via a network.

The user may store (locally or remotely, such as at the server) and/or transfer (such as sell) the user's conductor file to consumers. The user may also use the file, such as for a DJ performance. The user, a purchaser/consumer, or a DJ may use the conductor file to replay the plurality of tracks. The plurality of tracks are played simultaneously as directed by the conductor file and streamed from the server to the client. A plurality of clients may listen and/or view a performance of the tracks as presented by the server as directed by the conductor file.

Advantageously, since the original tracks reside with the server and performances are generated by utilizing those tracks, access and control to the tracks is ensured. For example, if a legal or other issue arises with one or more of the tracks (such as if an artist requires all their tracks be removed), the server controls access to the track(s). For example, the server may prevent access to a track, whereby any conductor file that utilized or reference that particular track would be inoperable (i.e. because the performance is governed by the server, even an existing conductor file does not permit access or use of the track). In such an instance, the server might send a notification or error to the effect that the track(s) is not available.

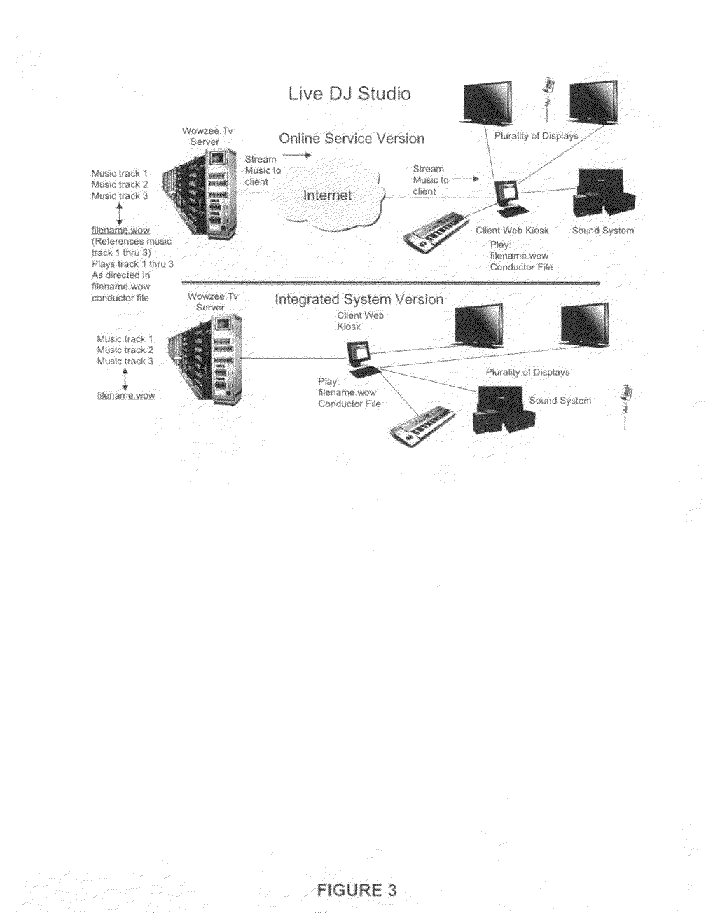

For the DJ who wishes to use the plurality of tracks in accordance with a conductor file for a live performance, the DJ may use an online service which plays the tracks in accordance with the conductor file(s), allowing the DJ to use a presentation kiosk to interact as part of a live performance with the pre-recorded music. In one embodiment, as illustrated in FIG. 3, an online server may utilize a service with all files stored in a data repository on the server for the DJ, while in an alternative embodiment the system utilizes a replicated server having a subset of files stored in a mobile mini data repository associated with the DJ's personal professional account.

In one embodiment, the DJ kiosk includes a web browser and interfaces to a plurality of graphical displays, a sound system, a microphone, a keyboard, and other musical/audio/visual equipment to add a live performance to the DJ's pre-recorded files. This enables the DJ to play the pre-recorded work while also providing a live performance, such as at a dance club. In the event the DJ is not present in the dance club, the DJ studio kiosk may utilize the web browser with a connection to the server to play one of a plurality of music and video streams while broadcasting to the kiosk's integrated large screen displays and sound system.

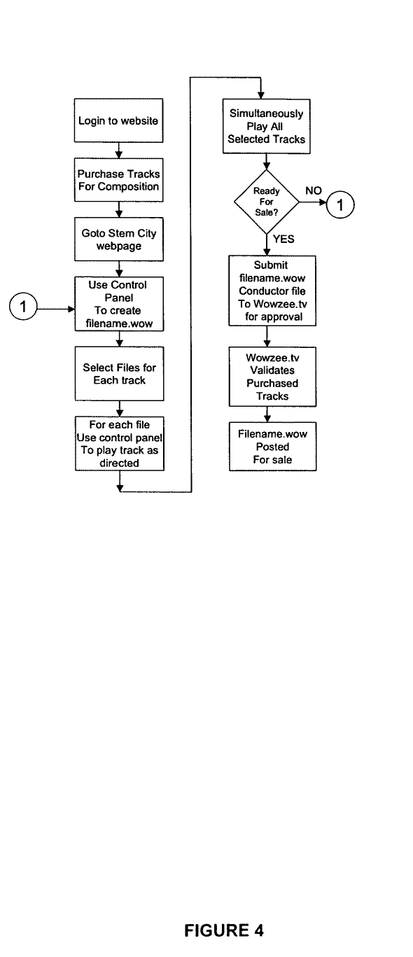

FIG. 4 illustrates one method of creating a conductor file. As illustrated therein, in one embodiment, a user accesses the server, such as by logging into their account via a website associated with the server, such as wowzee.tv. The user then purchases or selects the tracks they wish to use. The tracks are placed in or associated with the user's account and are then available for use as part of a conductor file. The user may then go to another website, such as a “Stem City” website, whereby a graphical panel or interface is provided to the user, allowing the user to select individual tracks which are played as directed by the user. Once the user sets up each of the tracks, the user may preview the conductor file by requesting that the server play all of the tracks incorporated within the conductor file.

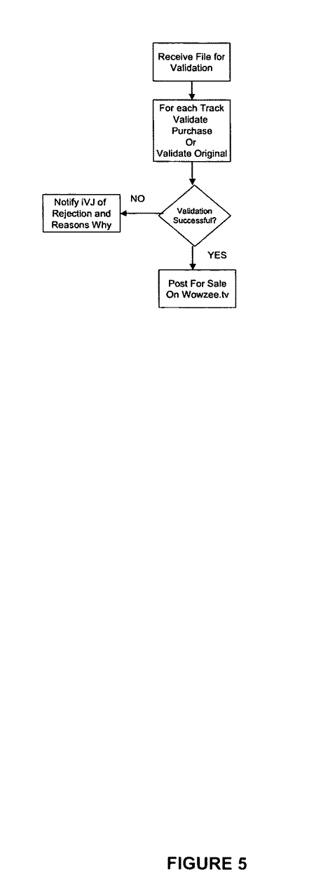

When the user is happy with the conductor file, the user may store the file for future use, including for sale or use by third parties. As illustrated in FIG. 5, in one embodiment, the server validates that all of the referenced original tracks are authorized for use in a conductor file. If the verification is successful, the file is placed on the site for sale or access to third parties, such as consumers/DJs. If the verification fails, the file is rejected by the server/website and sent back to the user with information related to the verification failure.

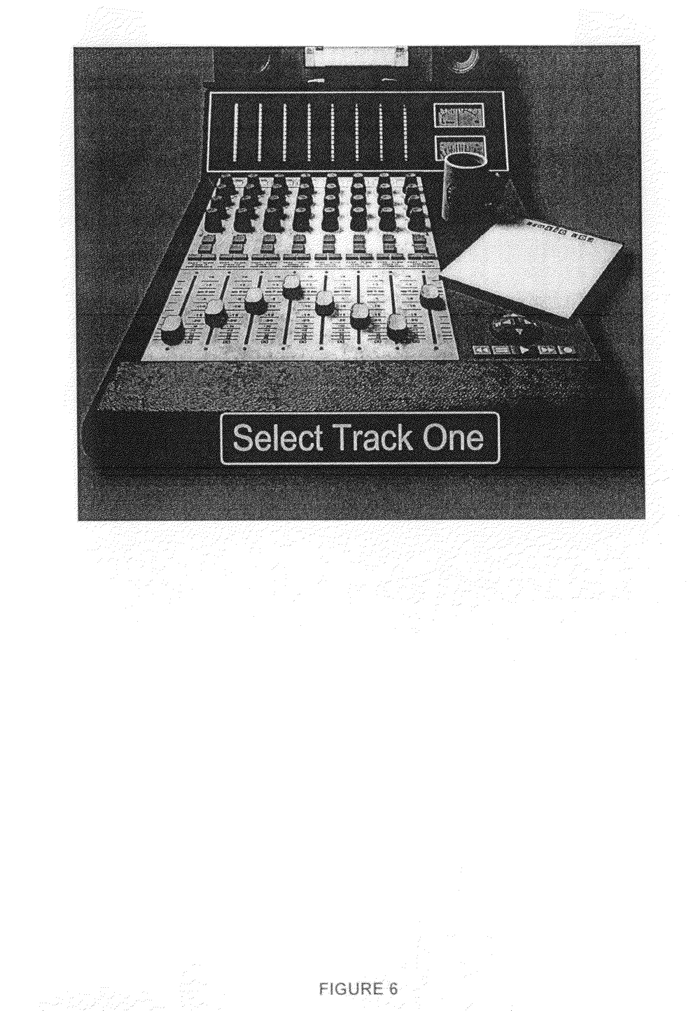

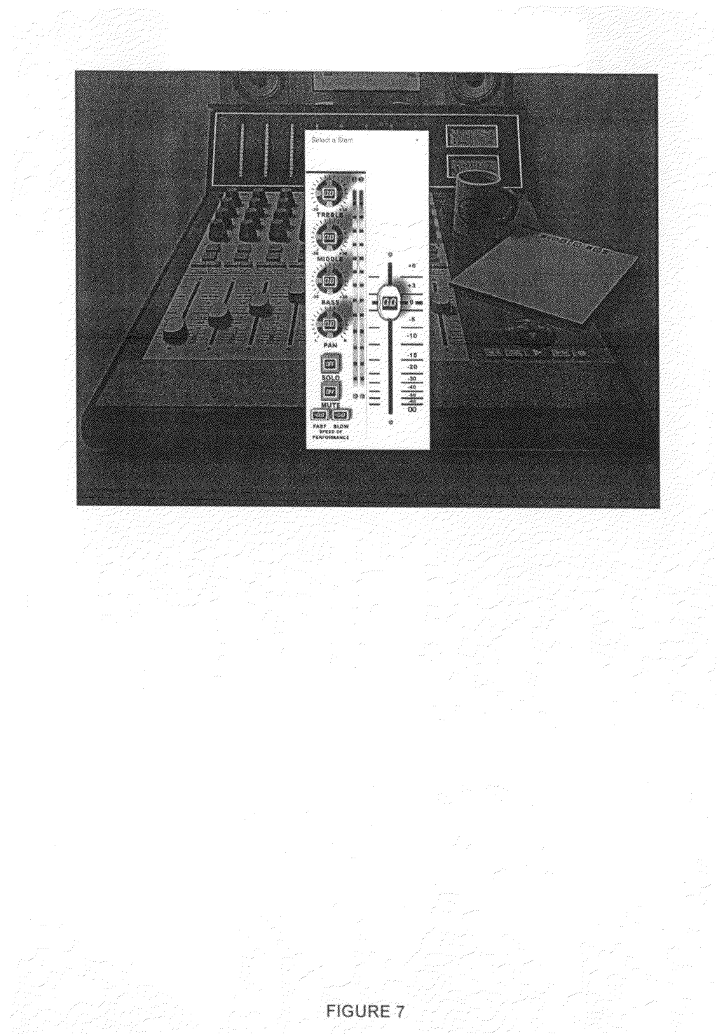

As illustrated in FIGS. 6 and 7, in one embodiment, a user selects tracks of interest for their conductor file using a website graphical user interface. Each selected track or musical stem is then played as desired by the user. The graphical user interface enables the user to play the selected track as desired. The control commands are then stored in a conductor file.

The present invention is also applicable to video tracks and/or audio and visual tracks or works.

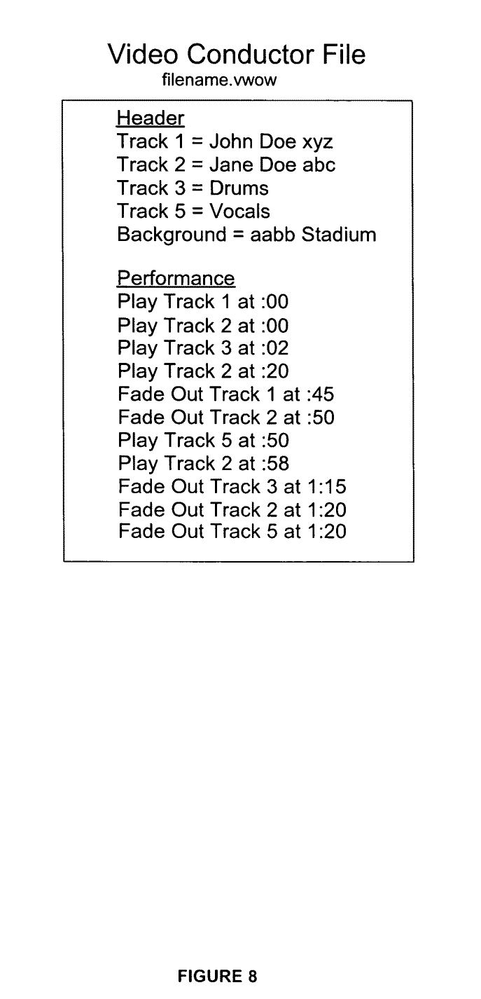

In one embodiment, each musical track or stem may incorporate a video track. A user may record a track such as a solo guitar track by performing the track in a video against a blue or equivalent background. This blue background becomes transparent when combining a plurality of similar videos. For example, the user may select a guitar performance, a drum performance, a vocal performance, and a bass performance. Each of the performances is recorded in video against a blue background. The user goes through the same process used to create a conductor file as previously described. In this embodiment, the conductor file, such as illustrated in FIG. 8, is created signifying a video file(s).

The user selects the video recording track parameters for start, stop, volume, etc. as previously described with relative to audio tracks. When the tracks are combined and played as in accordance with the conductor file, the blue background becomes transparent, enabling the user to select a common background for all of the video tracks. The user may select from a plurality of backgrounds such as places, a common stage, stadium or outdoor location, for example.

The user may fade a video track in and out, which in turn causes a specific video track or performance to disappear, leaving only the remaining tracks displayed. In this way, a dynamic performance can be built by combing the plurality of video performances when played as directed by the conductor file.

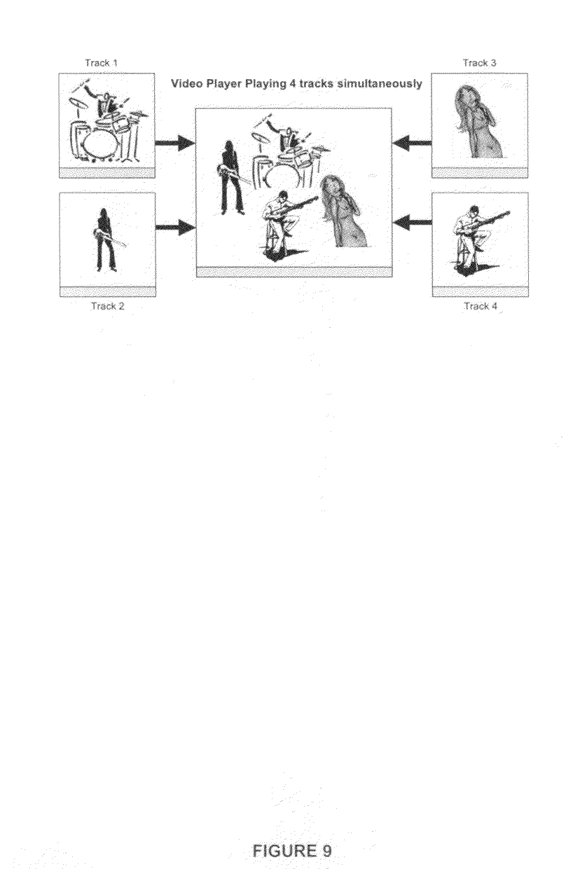

When the conductor file is used, the combined performance is displayed on a single video screen with a common background video wherein the tracks are played as directed by the conductor file. FIG. 9 illustrates one example, in which a single video performance recorded on a blue background, when combined with a selected common background, creates a single video performance.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A method of creating a musical performance comprising:
storing a plurality of individual original audio tracks at a remote server;
accepting a user request to utilize one or more of tracks selected from said original audio tracks to create a new user-created compilation work;
accepting input from said user regarding a command file comprising commands regarding the performance of said plurality of selected tracks as said user-created compilation work;
storing said command file; and
performing said user-created compilation work by utilizing said selected tracks in accordance with said command file, without altering said original audio tracks.

2. The method in accordance with claim 1 wherein said individual original audio tracks are stored electronically.

3. The method in accordance with claim 1 wherein said step of accepting input comprises presenting a graphical user interface to said user and accepting input to said graphical user interface.

4. The method in accordance with claim 1 further comprising storing said plurality of individual audio tracks with one or more limitations upon usage of said tracks.

5. The method in accordance with claim 1 further comprising the step of receiving said plurality of individual audio tracks from different artists for use by users.

6. The method in accordance with claim 1 further comprising the step of charging a fee for each of said tracks accessed by said user.

7. The method in accordance with claim 1 wherein said command file is stored at said server.

8. The method in accordance with claim 1 wherein said step of performing said user-created compilation work comprises streaming data representing said compilation to said user over a network.

9. The method in accordance with claim 1 further comprising permitting third parties to access said command file.

10. The method in accordance with claim 9 further comprising the step of charging for access to said command file.

11. A method of creating a user-created musical work in an online environment comprising the steps of:
accepting a plurality of individual original audio tracks in electronic form from a plurality of artists;
storing said audio tracks at a computing device;
transmitting a graphical user interface to a user at a user's computing device;
accepting input from said user via said interface to create a command file, said command file designating two or more selected tracks from said stored audio tracks, and a plurality of instructions regarding the performance of said selected tracks;
receiving said command file from said user; and
transmitting to said user said user-created musical work comprising said selected tracks performed in accordance with said command file, without altering said original audio tracks.

12. The method in accordance with claim 11 further comprising the step of charging said user for accessing each selected track.

13. The method in accordance with claim 11 wherein said instructions comprise one or more of a timing and duration of play of one or more portions of each selected track.

14. The method in accordance with claim 11 wherein said step of transmitting comprises streaming data representing said user-created musical work to said user's computing device.

15. The method in accordance with claim 11 further comprising the step of validating said command file for use.

16. The method in accordance with claim 15 wherein said step of validating comprises comparing said command file to one or more limitations of use associated with each of said original tracks.

17. The method in accordance with claim 11 further comprising accepting a request by a third party to access said command file and transmitting said user-created musical work to said third party.
